(19) United States
(12) Patent Application Publication
(10) Pub. No.: US 2009/0029320 A1
(43) Pub. Date: Jan. 29, 2009

(54) Extracoronal Attachment and Method for the Production Thereof

(75) Inventors: Adrian Auderset, Biel/Bienne (CH); Jean-Fred Studer, Lamboing (CH); Mathias Strazza, Nidau (CH)

Correspondence Address: FOLEY AND LARDNER LLP;SUITE 500, 3000 K STREET NW, WASHINGTON, DC, 20007, US

(73) Assignee: Cendres & Metaux SA

(21) Appl. No.: 11/887,960

(22) PCT Filed: Apr. 4, 2006
(86) PCT No.: PCT/CH2006/000192

§ 371 Date: Oct. 5, 2007

(30) Foreign Application Priority Data
Apr. 8, 2005 (EP) 05405284.0

(51) Int. Cl. A61C 13/265

(52) U.S. Cl. 433/182

(57) ABSTRACT

The extracoronal attachment comprises a female part (65), which is to be connected to the dental prosthesis, and a male part, which can be fastened to a natural tooth or implant and which has an approximal part (51). The approximal part has, on each of two opposite longitudinal sides, at least one longitudinal groove (20) or longitudinal rib inside of which a corresponding longitudinal rib (30) or longitudinal groove of the female part enters whereby establishing a positive connection, and has at least one occlusally facing bearing surface, on which the female part rests with a supporting surface. The female part comprises a housing, with which the longitudinal ribs (30) or longitudinal grooves of the female part and the supporting surface are provided as a single piece.

The present invention relates to an extra-coronal attachment according to the precharacterising part of claim 1 and to a method for the production of such an attachment.

Many different types of attachment are known, a distinction generally being drawn between intra-coronal attachments, in which the male part is anchored in the natural tooth or implant, and extra-coronal attachments, in which—as in the present application—the male part is fastened to the natural tooth or implant. In contrast to intra-coronal attachments, the use of an extra-coronal attachment enlarges the anatomical shape of the tooth or the external shape of the implant. The extra-coronal variant here constitutes a minimally invasive option for a natural tooth.

Extra-coronal attachments of the aforementioned type are disclosed, for example, by the patent specifications EP 0 298 909 B1 and EP 0 659 063 B1 from the same applicant. One of the advantages of these attachments is that they do not need any stabilizer, which is joined to the attachment part by an overcast, also referred to as a turn. Excessively high stresses on the attachment, however, can lead to unwanted relative movements between the crown of the tooth or the implant and the dental prosthesis or, in the worst case, even to fracturing of the male part.

The patent application DE 196 19 786 A1 discloses a further attachment of the aforementioned type, in which the male part and the female part can be fitted together and torsionally locked. In order to absorb rotational movements, the dental prosthesis comprises a bow-shaped shear dissipation arm as an integral part of a skeletal reinforcement. The shear dissipation arm is designed as a separate part of the male part and female part and engages in a V-shaped notch. The notch is relatively difficult to produce and makes any reproducible production on an industrial scale more difficult. The provision of an additional shear dissipation arm furthermore results in a relatively complex construction, which leads to a dental prosthesis that is intricate and expensive to produce.

Proceeding from this prior art, an object of the present invention is to eliminate the said disadvantages and to improve the attachment of the aforesaid type so that it is capable of bearing greater load stresses without the need for an additional shear dissipation arm.

An attachment which achieves this object is specified in claim 1. The other claims describe preferred embodiments and a method for the production of an attachment according to the invention.

The invention will be explained below on the basis of preferred exemplary embodiments and with reference to drawings, in which:

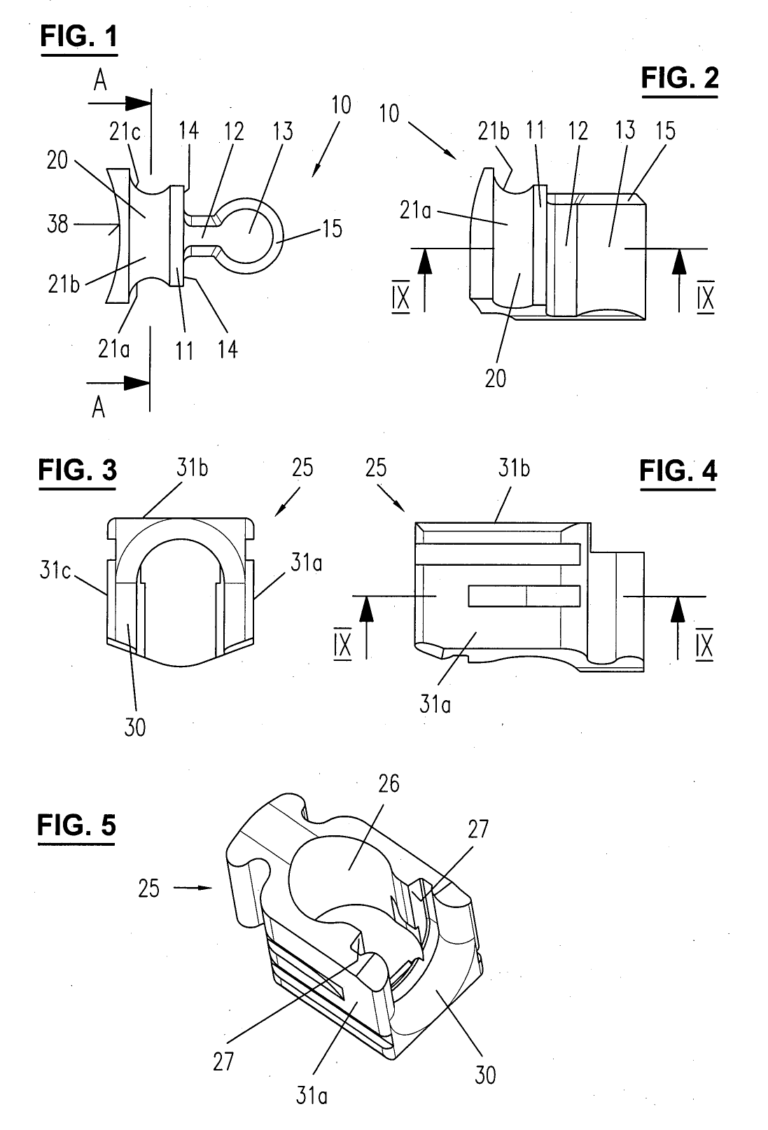

FIG. 1 shows a top view of a male part according to a first exemplary embodiment of the attachment according to the invention;

FIG. 2 shows a side view of the male part according to FIG. 1;

FIG. 3 shows a front view of a female part according to the first exemplary embodiment of the attachment according to the invention;

FIG. 4 shows a side view of female part according to FIG. 3;

FIG. 5 shows a perspective view of the female part according to FIG. 3 from the basal side;

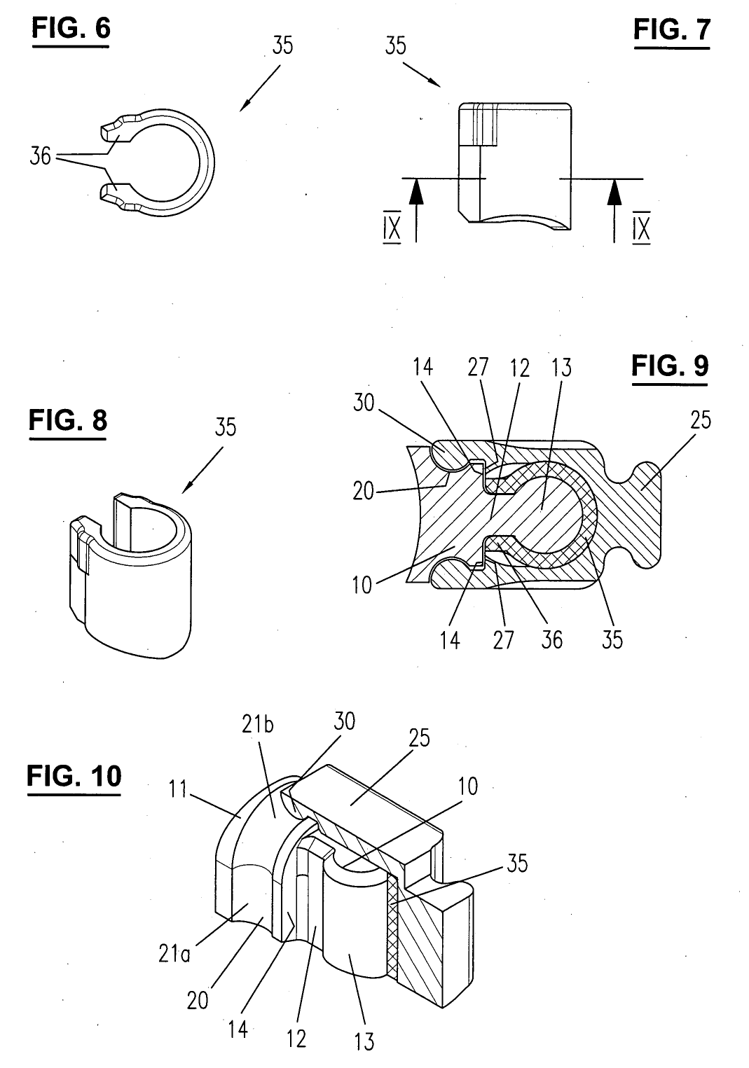

FIG. 6 shows a top view of a friction part according to the first exemplary embodiment of the attachment according to the invention;

FIG. 7 shows a side view of the friction part according to FIG. 6;

FIG. 8 shows a perspective view of the friction part according to FIG. 6 from above;

FIG. 9 a section through the assembled attachment according to the first exemplary embodiment in the plane IX-IX;

FIG. 10 shows a perspective, partially section view of the assembled attachment according to the first exemplary embodiment;

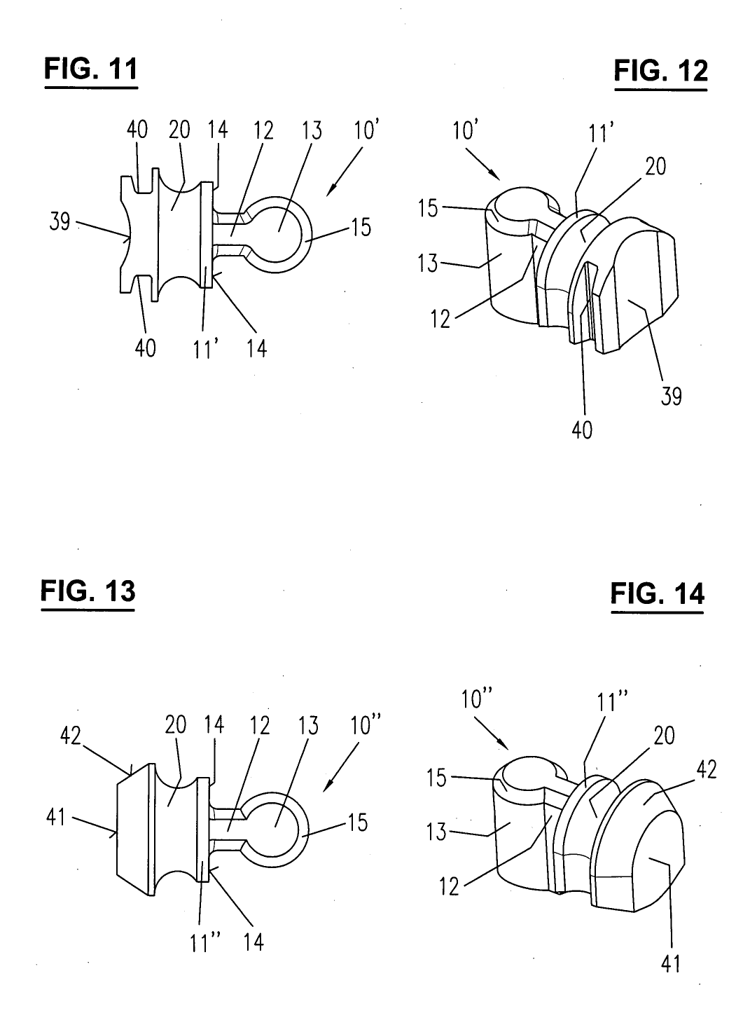

FIG. 11 shows a top view of a male part according to a second exemplary embodiment of the attachment according to the invention;

FIG. 12 shows a perspective view of the male part according to FIG. 11;

FIG. 13 shows a top view of a male part according to a third exemplary embodiment of the attachment according to the invention;

FIG. 14 shows a perspective view of the male part according to FIG. 13;

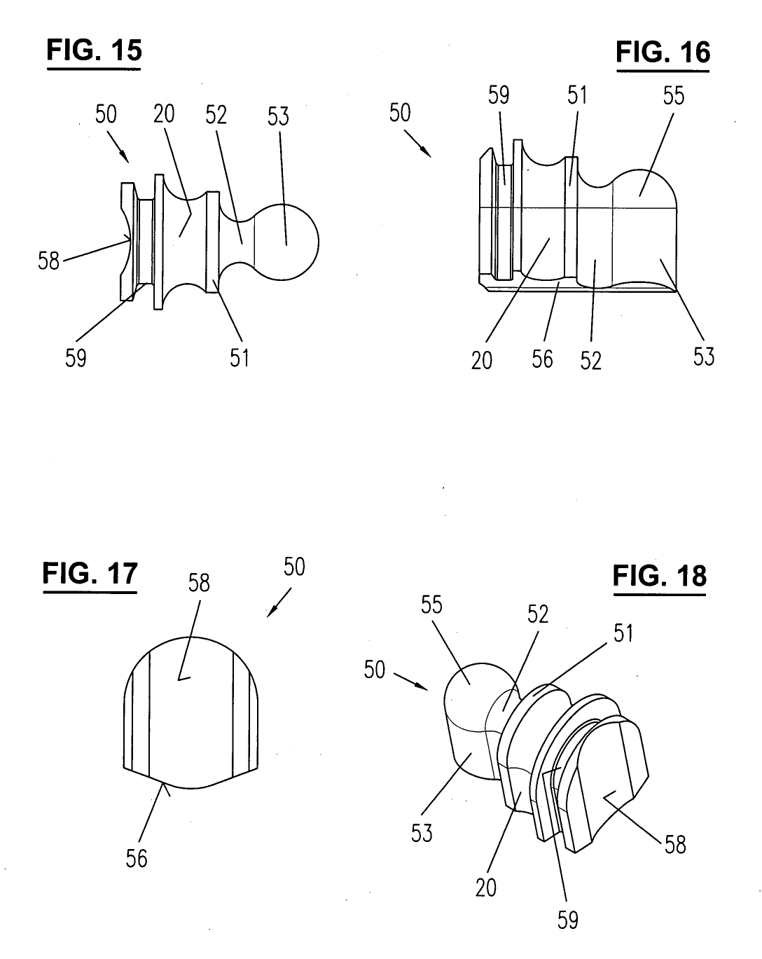

FIG. 15 shows a top view of a male part according to a fourth exemplary embodiment of the attachment according to the invention;

FIG. 16 shows a side view of the male part according to FIG. 15;

FIG. 17 shows a front view of the male part according to FIG. 15;

FIG. 18 shows a perspective view of the male part according to FIG. 15;

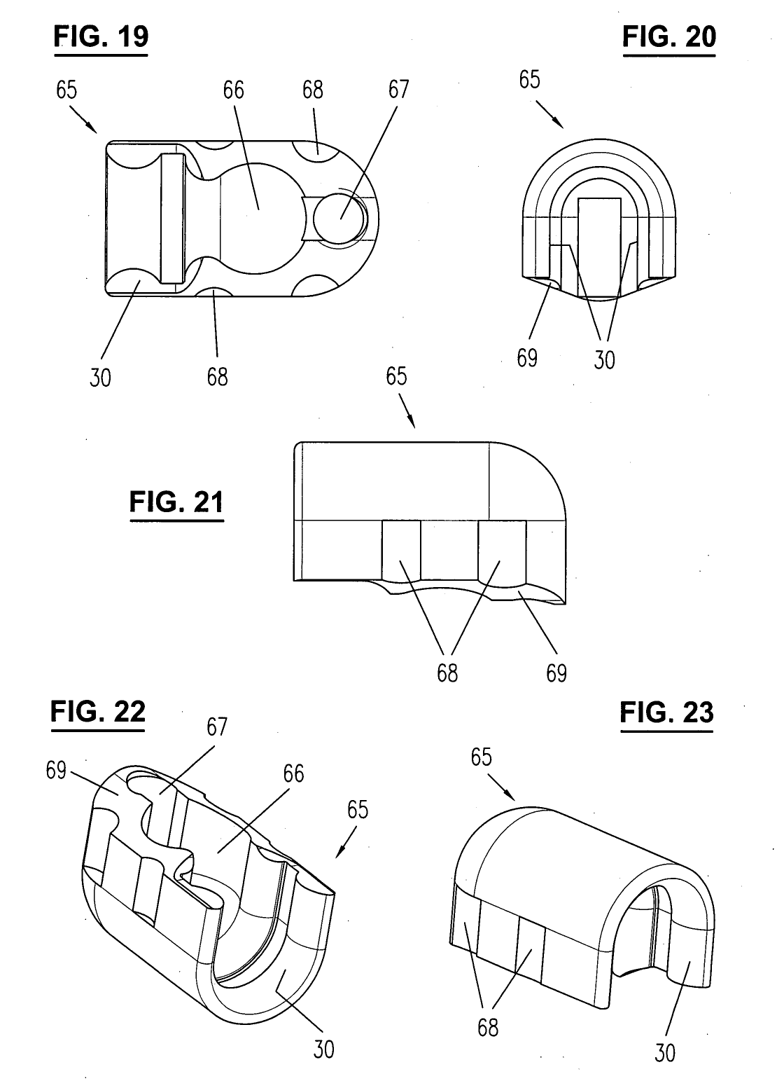

FIG. 19 shows a view of the female part from below according to the fourth exemplary embodiment of the attachment according to the invention;

FIG. 20 shows a front view of the female part according to FIG. 19;

FIG. 21 shows a side view of the female part according to FIG. 19;

FIG. 22 shows a perspective view of the female part according to FIG. 19 from the basal side;

FIG. 23 shows a perspective view of the female part according to FIG. 19 from above;

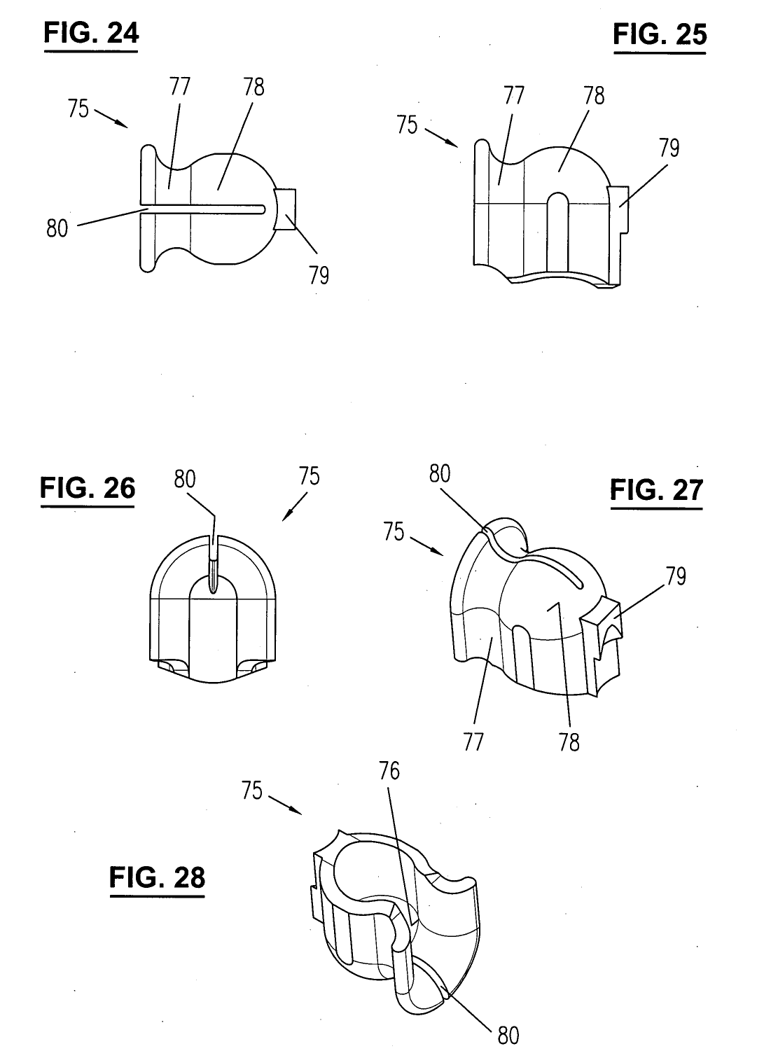

FIG. 24 shows a top view of the friction part according to the fourth exemplary embodiment of the attachment according to the invention;

FIG. 25 shows a side view of the friction part according to FIG. 24;

FIG. 26 shows a front view of the friction part according to FIG. 24;

FIG. 27 shows a perspective view of the friction part according to FIG. 24 from above;

FIG. 28 shows a perspective view of the friction part according to FIG. 24 from the basal side;

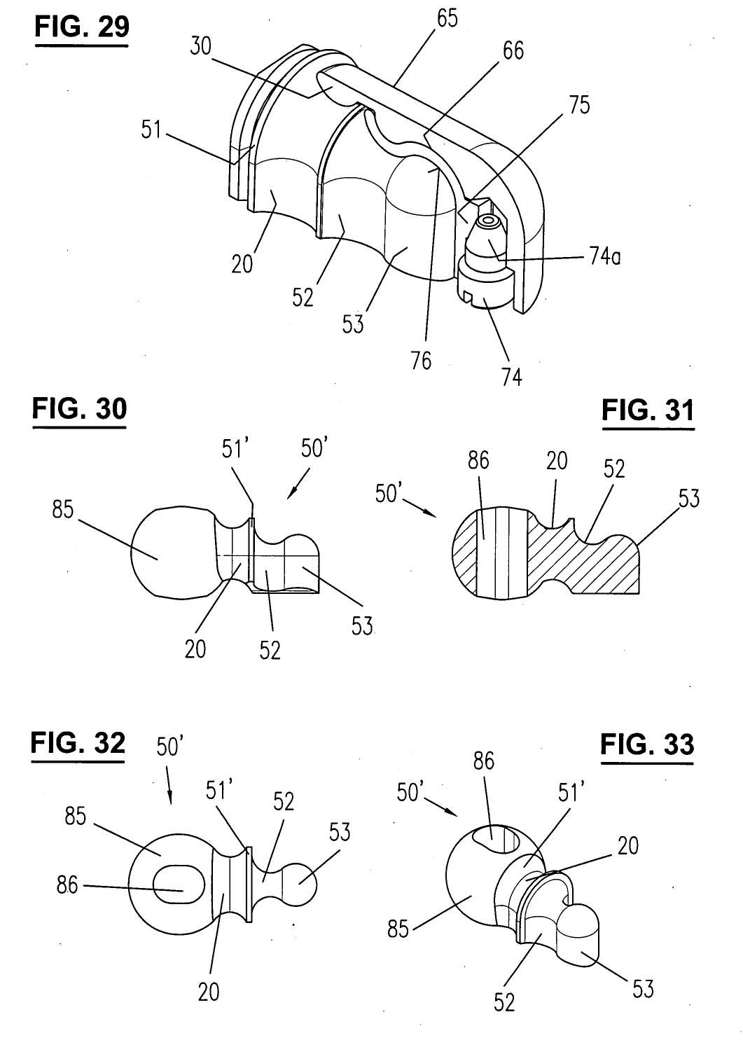

FIG. 29 shows a perspective, partially sectional view of the assembled attachment according to the fourth exemplary embodiment;

FIG. 30 shows a side view of the male part according to a fifth exemplary embodiment of the attachment according to the invention;

FIG. 31 shows a sectional side view of the male part according to FIG. 30;

FIG. 32 shows a top view of the male part according to FIG. 30;

FIG. 33 shows a perspective view of the male part according to FIG. 30;

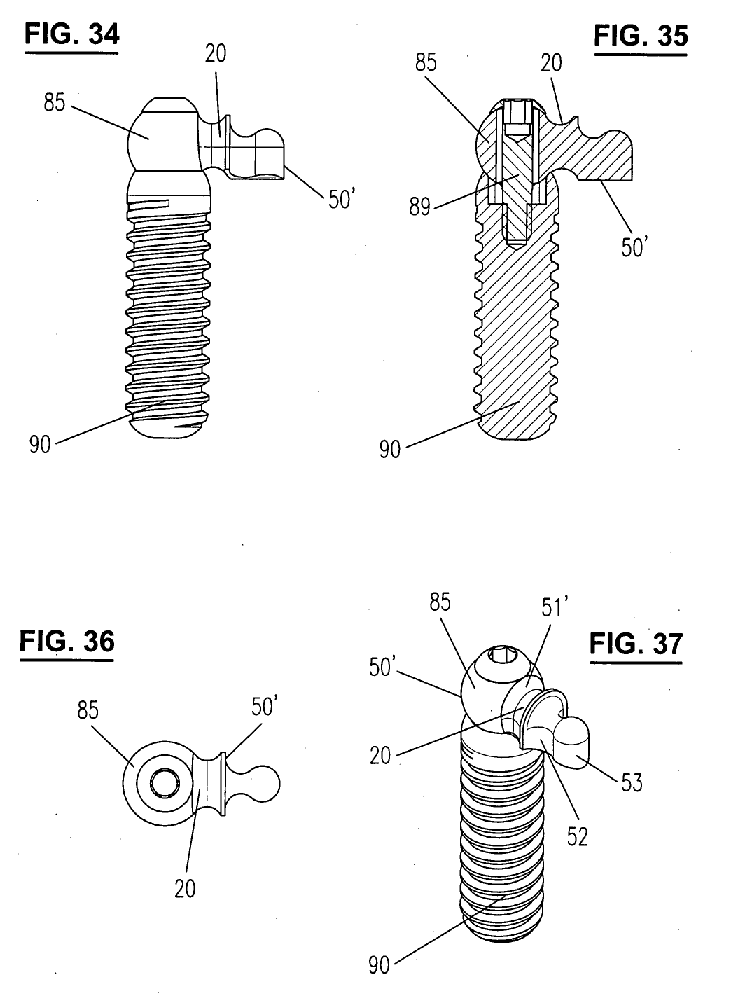

FIG. 34 shows a side view of an implant with male part according to FIG. 30;

FIG. 35 shows a sectional side view of the arrangement according to FIG. 34;

FIG. 36 shows a top view of the arrangement according to FIG. 34;

FIG. 37 shows a perspective view of the arrangement according to FIG. 34;

FIG. 38 shows a view of a sixth exemplary embodiment of the attachment according to the invention from below;

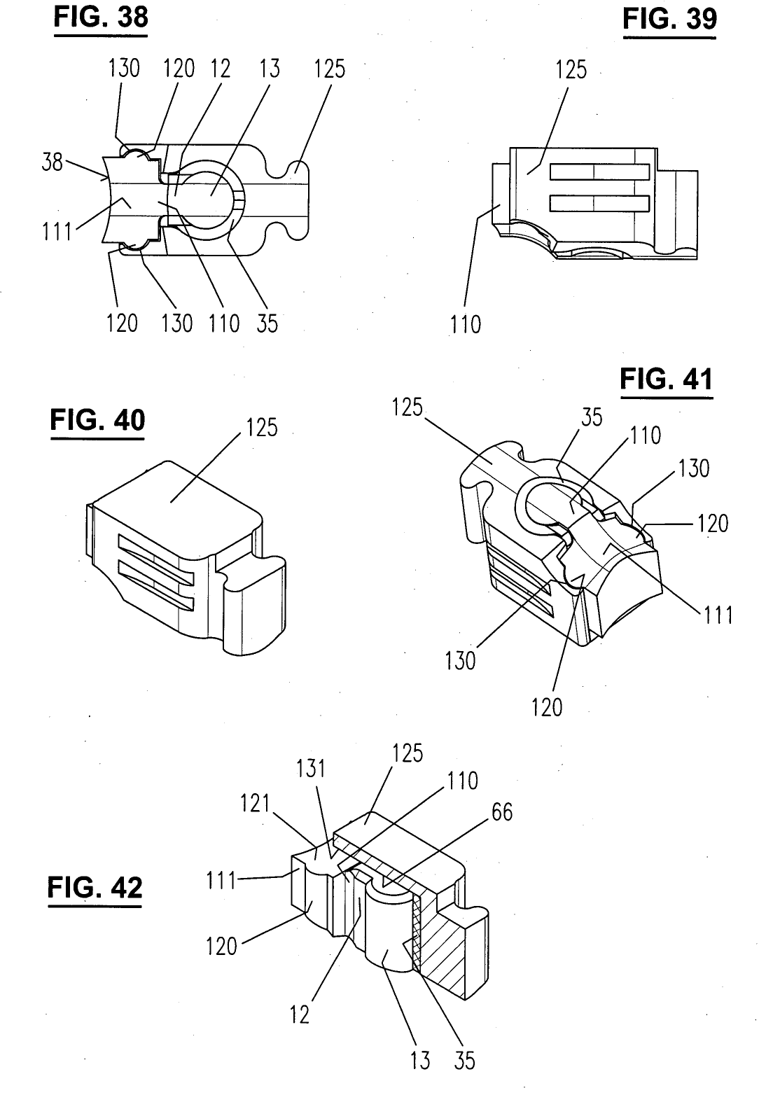

FIG. 39 shows a side view of the attachment according to FIG. 38;

FIG. 40 shows a perspective view of the attachment according to FIG. 38 from above;

FIG. 41 shows a perspective view of the attachment according to FIG. 38 from below;

FIG. 42 shows the view according to FIG. 40, the female part and the friction part being shown in section;

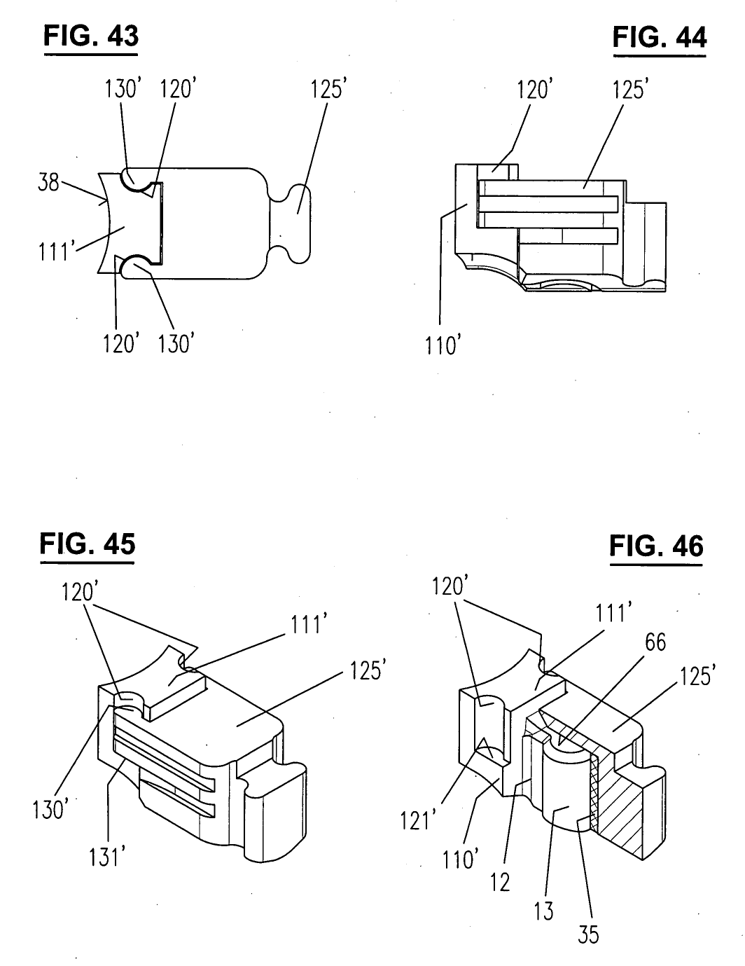

FIG. 43 shows a top view of a seventh exemplary embodiment of the attachment according to the invention;

FIG. 44 shows a side view of the attachment according to FIG. 43;

FIG. 45 shows a perspective view of the attachment according to FIG. 43;

FIG. 46 shows the view according to FIG. 45, the female part and the friction part being shown in section;

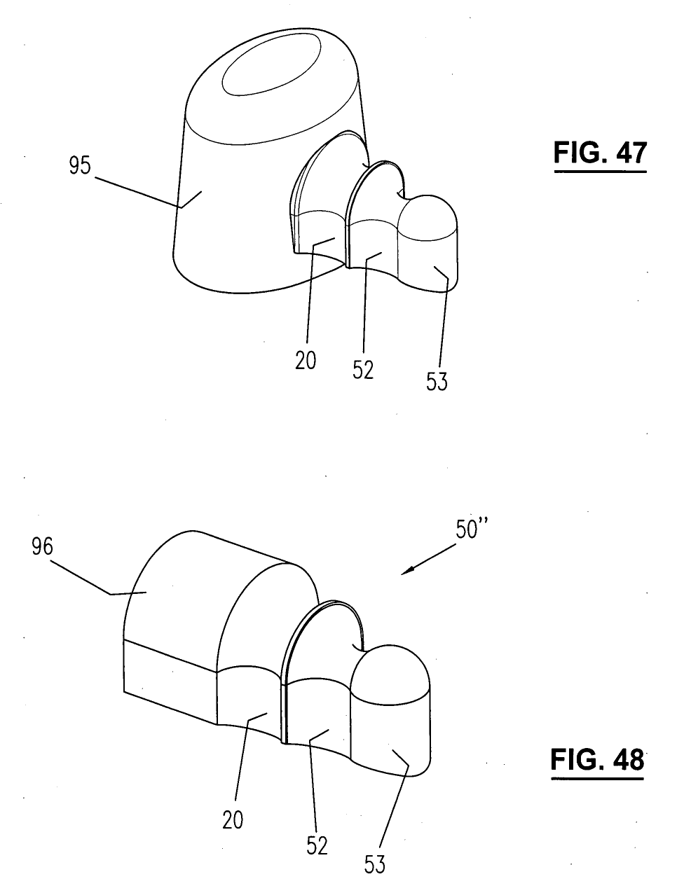

FIG. 47 shows a tooth crown with a male part of a attachment according to the invention; and

FIG. 48 shows a basic shape of the male part for software modelling.

### FIRST EXEMPLARY EMBODIMENT

As can be seen from FIGS. 1 and 2, the male part 10 comprises an approximal part 11, which can be fastened (soldered) to a crown, for example, and which is connected by way of a web 12 to a head part 13. On each of its two longitudinal sides 21a and 21c the approximal part 11 is provided with a longitudinal groove, the two longitudinal grooves extending in the insertion direction of the female part and being joined together on the occlusally facing side 21b to form an occlusal bearing surface. A stabilising groove 20 is thereby formed, which extends from the one longitudinal side 21a of the approximal part 11 via the upper, i.e. the occlusal side 21b, to the other longitudinal side 21c of the approximal part 11.

In the plane of section, indicated by the line A-A in FIG. 1, the stabilising groove 20 has a substantially U-shaped profile and has a round cross section, which preferably remains substantially constant along the stabilising groove 20. The cross section of the stabilising groove 20 is preferably of a substantially circular segmental shape, the arc length being less than half the circumference of the circle. The plane sides of the approximal part 11 situated on either side of the web 12 form additional seating surfaces 14 for the female part 25.

The head part 13 is substantially cylindrical, the web 12 and the head part 13 having bevelled surfaces 15 on the occlusal side. As FIG. 1 shows, the diameter of the head part 13 and the thickness of the web 12 are less than the thickness of the approximal part 11. The cross sectional area of the approximal part 11 in the plane of section A-A is therefore greater than a cross sectional area running parallel to the plane A-A through the web 12 or the head part 13.

FIGS. 3-5 show the female part 25 to be joined to the dental prosthesis. Said female part is embodied as a housing, which is open on the front and lower side. The housing is closed on the longitudinal sides 31a and 31c, i.e. on the buccal or labial side and closed on the lingual or palatal side, so that a stable shape is formed. The occlusal side 31b and rear side of the housing is also closed. The female part 25 has a recess 26, the shape of which is defined by surfaces that are substantially complementary to the surfaces of the head part 13, the web 12, the seating surfaces 14 and the stabilising groove 20. In particular, the female part comprises seating surfaces 27, and at the front end a stabilising rib 30, which extends from the one longitudinal side 31a of the female part 25 via the occlusal side 31b to the other longitudinal side 31c.

As FIG. 3 in particular shows, the stabilising rib 30—like the stabilising groove 20—has a U-shaped profile. When the male part 10 and the female part 25 are joined together, the stabilising rib 30 engages in the stabilising groove 20, so that a positively interlocking connection is formed.

The friction part 35, as can be seen from FIGS. 6-7, is substantially embodied as a laterally open tubular sleeve, which has extensions 36. The friction part 35 is made of plastics and makes it possible to compensate for tolerances in the interaction between the male part 10 and the female part 25. The friction part 35 also has a damping effect when a load stress is placed on the attachment. It is furthermore possible, through an appropriate choice of the thickness of the friction part 35, to adjust the force needed in order to separate the female part 25 from the male part 10 and to remove the prosthesis. This method of activating the attachment is disclosed, for example, by the patent specification EP 0 659 063 B1.

As can be seen from FIGS. 9 and 10, when the attachment is put together, the female part 25 with its stabilising rib 30 engages in the stabilising groove 20 and the seating surfaces 14 and 27 face one another. The friction part 35 encloses the head part 13 and with the extensions 36 bears against the web 12.

The tolerances on the dimensions of the male part 10 and the female part 25 are selected so that in the unstressed state the female part 25 is supported on the stabilising groove 20 and not on the web 12 or the head part 13.

The approximal part 11 of the male part 10 shown in FIGS. 1 and 2 is provided with a concave approximal surface 38, which can be joined to the crown, by soldering for example.

### SECOND AND THIRD EXEMPLARY EMBODIMENT

FIGS. 11 and 12, 13 and 14 show two further variants of male parts 10′ and 10″, which can be joined to the crown, for example, by casting on or lasering. In FIGS. 11-14, parts corresponding to the parts in FIGS. 1 and 2 are provided with the same reference numerals. The male parts 10′ and 10″ together with the female part 25 and the friction part 35 can be used to form an attachment.

As can be seen from the FIGS. 11 and 12, the approximal part 11′ of the cast-on male part 10′ has a concave approximal surface 39 with two longitudinal slots 40 on its end face.

As can be seen from the FIGS. 13 and 14, the approximal part 11″ of the male part 10″ that can be joined by lasering comprises a plane approximal surface 41 on the end face, which adjoins a bevelled, substantially U-shaped edge surface 42.

### FOURTH EXEMPLARY EMBODIMENT

A further exemplary embodiment of the attachment according to the invention is represented in the FIGS. 15-29. The male part 50 represented in FIGS. 15-18 differs from the male part 10′ largely in that the occlusal area 55 of the head part 53 and the web 52 have round external surfaces. The head part 53 and the web 52 have an omega-shaped cross section in the lower, that is to say the basal area of the male part 50. The occlusal area 55 of the head part 53 has a substantially spherical shape. The web 52 takes the form of a groove of round cross section, which extends substantially in a U-shape from the one longitudinal side of the web 52 via the occlusal side to the other longitudinal side of the web 52. Besides a round design of the stabilising groove 20 and the stabilising rib 30, the round design shape of the web 52 and the head part 53 in the occlusal area also facilitate the fitting of the prosthesis. Furthermore, the round design shape of the web 52 and the head part 53 reduces the risk of damage to the friction part 75.

As can be seen from the FIG. 17, the bottom surfaces 56 of the male part 50 are bevelled, so that they taper at an obtuse angle towards the centre of the male part 50. Once the male part 50 is fastened in the mouth, the bevelled surfaces 56 facilitate cleaning by means of dental floss, for example.

The approximal part 51 with the stabilising groove 20 is similar in design to the male part 10′. In particular, as can be seen from FIG. 15, the diameter of the head part 53 and the thickness of the web 52 are less than the thickness of the approximal part 51, so that the cross section in the area of the stabilising groove 20 is greater than in the area of the web 52 and the head part 53.

The male part 50 is designed for fastening by casting on. For this purpose the approximal part 51 has a U-shaped casting attachment slot 59 on the end face and a concave approximal surface 58. The casting attachment slot 59 extends from the one longitudinal side of the approximal part 51 via the occlusal side to the other longitudinal side of the approximal part 51. Compared to the exemplary embodiment with two longitudinal slots 40, as shown in FIGS. 11 and 12, the casting attachment slot 59 has the advantage that the casting attachment surface is more clearly defined by the other surfaces of the approximal part 51, thereby allowing more precise casting on. With a casting attachment slot 58 carried over the occlusal side, it is also possible to achieve a better aesthetic result.

At the end face the approximal part 51 can naturally also be designed as shown in FIG. 1, 12 or 14, depending on the desired method of fastening.

The female part 65 shown in FIGS. 19-23 is embodied as a housing, which is open on the front and lower side. The female part 65 has a recess 66, in which the web 52 and the head part 53 and the friction part 75 can be accommodated. Adjoining the recess 66, the female part 65 has a substantially cylindrical recess 67, which serves to receive the a friction screw 74. At the front end the female part 65 is provided with a stabilising rib 30, which extends from the one longitudinal side of the female part 65 via the occlusal side to the other longitudinal side and which is capable of engaging in the stabilising groove 20 of the male part 50.

The female part 65 has a rounded external shape, so that it is less voluminous than an angular embodiment and therefore takes up less space in the prosthesis. In the basal area the outside of the female part 65 is provided with depressions 68, which ensure a better grip in the dental prosthesis and therefore prevent the female part 65 from being torn out of the prosthesis plastics. Like the male part 50, the bottom surfaces 69 are bevelled towards the centre of the female part 65.

FIGS. 24-28 show various views of the plastic insert serving as friction part 75. This is embodied as a housing, the internal surfaces being substantially complementary to the external surfaces of the head part 53 and the web 52. On the upper, i.e. the occlusal side, the friction part 75 accordingly also comprises a seating surface 76, which with the attachment assembled rests on the upper side of the head part 53 and the web 52. The thickness of the friction part 75 is substantially constant. The external surface of the friction part 75—like the head part 53 and the web 52—accordingly has a U-shaped groove 77 and a spherical dome 78. This is provided with a projection 79, on which a friction screw 74 can act. The projection 79 may also be of conical design.

The friction part 75 has, at least in the centre, a longitudinal slit 80, so that it can expand and contract—according to the action of the friction screw 74—and thus exert a corresponding pressure on the female part 65. This permits a corresponding activation of the attachment. The friction part 75 may be provided with additional slits parallel to the longitudinal slit 80. As a simplified variant of the friction part, it is also feasible to design this as a tubular sleeve with an omega-shaped cross section—as in FIGS. 6-8.

FIG. 29 shows a perspective view of the assembled attachment, the female part 65 and the friction part 75 being shown in section. As can be seen, the stabilising rib 30 engages in the stabilising groove 20. The friction screw 74 is inserted from below, i.e. the basal side, into the recess 67 in the female part 65. The friction screw has a conical head 74a, so that by screwing it in or out it is possible to increase or reduce the force acting on the projection 79.

### FIFTH EXEMPLARY EMBODIMENT

A further exemplary embodiment of the male part 50′ is represented in FIGS. 30-33. The head part 53, the web 52 and the stabilising groove 20 correspond to the respective parts of the male part 50 in the fourth exemplary embodiment. The female part 65 and the friction part 75 can be used as female part and friction part. The male part 50′, the female part 65 and—where present—the friction part 75 form an extra-coronal attachment, which can be fastened to an implant.

The approximal part 51′ comprises a round head 85 with a hole 86 for fastening to an implant 90. The round head 85 has a spherical external surface. The hole 86 takes the form of an elongated through-hole.

FIGS. 34-37 show the male part 50′, which is fastened to the post-shaped implant 90 by means of a screw 89. The elongated hole 86 affords a certain play, making it possible to adjust the angle between the male part 50′ and the implant axis within a limited range.

It is feasible, to fit further parts to the implant 90. For example, a bar can be fitted to form a retaining device with bar and attachment, to which a free-end bridge (so-called extension bridge) can be fastened. Possible bar constructions are described, for example, in the international patent application WO 02/062257 A1.

### SIXTH EXEMPLARY EMBODIMENT

The exemplary embodiment shown in FIGS. 38-42 differs from the first exemplary embodiment largely in that the approximal part 111 of the male part and the corresponding area of the female part 125 are designed differently. Parts which are the same as in FIGS. 1-10 are provided with the same reference numerals. As can be seen from FIGS. 38 and 42 in particular, the approximal part 111 comprises a longitudinal rib 120 on each of the opposing longitudinal sides, in which a corresponding longitudinal groove 130 of the female part 125 engages to form a positively interlocking connection. The longitudinal ribs 120 and the longitudinal grooves 130 extend in the insertion direction of the female part 125 and each have a round cross section. Adjoining the longitudinal ribs 120, the approximal part 111 on the upper side comprises an occlusally facing bearing surface 121, on which the female part 125 bears with a supporting surface 131. The bearing surface 121 and the supporting surface 131 are plane surfaces.

### SEVENTH EXEMPLARY EMBODIMENT

The exemplary embodiment shown in FIGS. 43-46 differs from the first exemplary embodiment largely in that the approximal part 111′ the male part 110′ and the corresponding area of the female part 125′ are designed differently. Parts which are the same as in FIGS. 1-10 are provided with the same reference numerals. The approximal part 111′ comprises a longitudinal groove 120′ on either side, which terminates before the lower end of the approximal part 111′. In each case this results in a step, which forms an occlusally facing bearing surface 121′. The female part 125′ comprises two longitudinal ribs 130′, which interlock in the corresponding longitudinal grooves 120′. The longitudinal grooves 120′ and the longitudinal ribs 130′ each have a round cross section. The undersides of the longitudinal ribs 130′ form supporting surfaces 131′, which rest on the bearing surface 121′. The bearing surface 121′ and the supporting surface 131′ are plane surfaces.

Advantages of the attachments hitherto represented include the following:
The female part is laterally held and occlusally supported by the longitudinal rib/groove and the continuous stabilising groove/rib, resulting in a rigid connection, which in addition to a buccal/labial and lingual/palatal action also acts on the occlusal side. This improves the connection between the male part and the female part, in particular so that even large torsional forces do not lead to relative movements between the male part and the female part. In particular, the occlusal support ensures that tilting moments, which tend to tilt the female part and the male part relative to one another, can be absorbed. The improved connection between the male part and the female part obviates the need for an additional shear dissipation arm, as is disclosed by DE 196 19 786 A1, for example. The female part is designed so that it also assumes the function of a shear dissipation arm.
The connection is arranged on the approximal part, i.e. on that part of the male part which has the largest cross sections. The female part can therefore be supported in the area of the largest male part cross sections, whilst the stress loading of the head part and the web is reduced. This reduces the wearing of attachment parts and increases the breaking strength of the male part. The greater load bearing capacity of the attachment is also due to the fact that the female part is supported on the approximal part and therefore close to the tooth crown or the implant, so that the leverage on the male part is minimised.
Giving the longitudinal groove/rib and the stabilising groove/rib a round design on the one hand facilitates the insertion of the prosthesis and on the other ensures that the connection is easier to make and is more precisely reproducible than the connection disclosed by DE 196 19 786 A1, for example.

The male part 10, 10′, 10″, 50, 50′, 110, 110′ and the female part 25, 65, 125, 125′ may be prefabricated, for which purpose they are produced from an orally resistant material. Examples of such materials are: titanium, metals such as precious metals, in particular self-hardening precious metal alloys or stainless steel, ceramics, plastics or glass-fibre reinforced matrix. It is also possible for the female part 25, 65, 125, 125′ alone to be prefabricated, whilst the male part 10, 10′, 10″, 50, 50′, 110, 110′ is made from a burn-out plastic material, so that the male part used in the mouth can be produced by casting.

The male part 10, 10′, 10″, 50, 50′, 110, 110′ is also suitable for production by means of a dental CAD/CAM-System (“Computer Aided Design/Computer Aided Manufacturing-System”). In particular the male part 50 and 50′ according to the fourth and fifth exemplary embodiments, which have round external surfaces, is suitable for such production.

A dental CAD/CAM-System comprises a scanner, by means of which the geometry of the dental stump or stumps or other areas of the patient's oral cavity can be registered and corresponding digitalised data can be generated, a computer with software (“CAD-area”), by means of which the object to be produced can be software-modelled on the basis of the data scanned in, and a computer-controlled machine (“CAM-area”), which produces the object on the basis of the software model. Scanning can be performed directly on the patient or on a model produced from an impression. Various generative production methods are known, which can be used on the machine. Examples of suitable production methods are:
chip-forming production methods such as milling, turning and/or grinding (production of the object from a workpiece blank by removing material);
wax impression (building up the object from thermoplastic drops);
stereo-lithography (polymerisation of a liquid phase by means of a laser beam);
sintering, in particular laser sintering (fusion and solidification of a powder);
galvanic coating;
3D-printing (solidification of a powder by a binder).

The dental CAD/CAM-system can advantageously be used to produce the male part integrally with the crown, crown cap, bridge or bridge structure from the basic material. FIG. 47 shows an example of an integral part with the crown cap 95 and male part with head part 53, web 52 and stabilising groove 20. The female part 65 and the friction part—either as a closed shape 75 or as an omega-shaped tubular sleeve 35—can ideally be used to form the attachment.

Production in ceramics, titanium, metal, plastics or a glass-fibre reinforced matrix is possible, according to the production method of the CAD/CAM-System. Production in ceramics has the advantage that any wearing of the male part, such as can occur in the case of the hitherto known male parts, due to the inclusion of odontolith and abrasive particles, for example, is virtually prevented.

In order to facilitate the input of data corresponding to the shape to be produced, data of the male part in a basic form 50″, like that represented in FIG. 48, are stored in the software-library of the dental CAD/CAM-System. The basic form 50″ comprises the head part 53, the web 52 and the stabilising groove 20, the shape of which remains constant, and a positioning part 96, which adjoins the stabilising groove and which can be positioned and/or adjusted by the software. For example, in order to produce the part according to FIG. 47, the geometry of the dental stump is scanned in, the crown cap is software-modelled onto the scanned-in dental stump, the basic shape 50″ of the male part according to FIG. 48 is loaded from the software-library and the positioning part 96 is positioned and where necessary modelled by the software, so that it comes to lie at the correct height above the gingiva, at the correct angle along the alveolar crest and in the correct insertion direction of the prosthesis. From the software model the computer then compiles a CAD-data file for controlling the machine, so that this produces the male part integrally with the crown cap 65. Instead of crown cap, a crown, a bridge or a bridge structure can also be integrally produced with the male part, in the same way as in this example.

The basic shape 50″ can be adapted and individualised as necessary in a common, industrial CAD-System and finally incorporated into the software library of the dental CAD/CAM system.

From the exemplary embodiments described here, numerous modifications will be open to the person skilled in the art, without departing from the scope of the invention, which is defined by the claims.

The approximal surface of the approximal part 11 of the male part 10, for example, can be designed in such a way that the male part can be adhesively bonded to the natural tooth or the implant. Together with this variant, the male parts 10, 10′, 10″, 50, 50′, 50″, 110 and 110′ form a system of male parts, which covers the currently most important methods of joining and processing, that is: casting of a burn-out male part, casting on, soldering on, laser attachment, phasing on (electro-spot welding) or adhesive bonding of a prefabricated male part, dental CAD/CAM-production with crown, crown cap, bridge or bridge structure, and direct screwing onto an implant. Through corresponding, geometric configuration the female part 25, 65, 125 or 125′ can ideally be used simultaneously for all processing variants.

In the first exemplary embodiment a screw-activated friction part with a projection like the projection 79 of the friction part 75 can also be used instead of the friction part 35. In the fourth exemplary embodiment it is also feasible to omit the projection 79 of the friction part 75, the recess 67 in the female part 65 and the friction screw 74, and instead to achieve activation of the attachment through a corresponding selection of the thickness of the friction part 75. In order to obtain a retentive holding force, an elevation can be provided on the inside of the friction part 35 or 75, which in attaching snaps into a corresponding slot in the male part.

It is also possible to provide a bolt mechanism, in order to bolt the female part 25, 65, 125, 125′ and the male part 10, 10′, 10″, 50, 50′, 110, 110′ together, or to provide a screw, in order to screw the attachment parts together. The shape of the female part 25, 65, 125, 125′ can be adapted to the male part 10, 10′, 10″, 50, 50′, 110, 110′ so that no friction part 35, 75 is necessary.

It is in general feasible to modify the female part 25, 65, 125 or 125′ so as to fulfil various joining functions together with the male part 10, 10′, 10″, 50, 50′, 110, 110′ (fricative, retentive, screwed, bolted, articulated etc.) and so as to form a system of female parts, for example.

It is also feasible to provide the male part 10, 10′, 10″, 50, 50′ with a stabilising rib and the female part 25, 65 with a stabilising groove and/or to provide the male part 10, 10′, 10″, 50, 50′ and female part 25, 65 with more than one stabilising groove or rib, which in each case extend from the one longitudinal side occlusally to the other longitudinal side.

In the sixth and seventh exemplary embodiment it is feasible to embody the longitudinal ribs 120, 130′ as longitudinal grooves and the longitudinal grooves 130, 120′ correspondingly as longitudinal ribs and/or to provide the male part 110, 110′ and the female part 125, 125′ with more than two longitudinal grooves or ribs.

1. Extra-coronal attachment
with a female part (25, 65, 125, 125′) to be connected to the dental prosthesis and
with a male part (10, 10′, 10″, 50, 50′, 110, 110′), which can be fastened to the natural tooth or implant (90) and which comprises an approximal part (11, 11′, 11″, 51, 51′, 111, 111′),
wherein
the approximal part on each of two opposing longitudinal sides comprises at least one longitudinal groove (20, 120′) or longitudinal rib (120), in which a corresponding longitudinal rib (30, 130′) or longitudinal groove (130) of the female part engages to form a positively interlocking connection, and at least one occlusally facing bearing surface (20, 121, 121′), on which the female part rests with a supporting surface (131, 131′),
the female part comprising a housing, with which the longitudinal ribs (30, 130′) or longitudinal grooves (130) of the female part and the supporting surface (131, 131′) are integrally formed.

2. The attachment according to claim 1, wherein the bearing surface of the male part (10, 10′, 10″, 50, 50′) is embodied as bearing groove or bearing rib, which together with the two longitudinal grooves or longitudinal ribs of the male part forms a stabilising groove (20) or stabilising rib, which extends from the one longitudinal side (21a) of the approximal part (11, 11′, 11″, 51, 51′) via the occlusal side (21b) of the approximal part to the other longitudinal side (21c) of the approximal part, and
the supporting surface of the female part is comprised of a supporting rib or supporting groove, which positively interlocks with the bearing groove or bearing rib.

3. The attachment according to claim 2, wherein the stabilising groove (20) and the stabilising rib (30) have a round cross section.

4. The attachment according to claim 1, wherein the longitudinal grooves (120′) of the male part (110′) or the female part are of stepped design so as to form the bearing surface (121′) and/or the upper side of the approximal part (111) of the male part (120) forms the bearing surface (121).

5. The attachment according to claim 1, wherein a friction part (35, 75) is arranged between the male part (10, 10′, 10″, 50, 50′, 110, 100′) and the female part (25, 65, 125, 125′).

6. The attachment according to claim 1, wherein the housing comprises a recess (26, 66) to accommodate a head part (13, 53) of the male part (10, 10′, 10″, 50, 50′, 110, 110′).

7. The attachment according to claim 1, wherein the approximal part (51′) comprises a round head (85) with at least one hole (86) for fastening to an implant (90).

8. The attachment according to claim 1, wherein
the male part (10, 110′, 10″, 50, 50′, 110, 110′) is of burn-out material, which is suitable for casting, and/or
the approximal part (11, 11′, 11″, 51, 51′) comprises approximal surfaces (38-42) for fastening the male part to the tooth or implant by casting on, soldering on, lasering on, adhesive bonding or screwing.

9. The attachment according to claim 1, wherein the housing is closed on the sides on which the longitudinal ribs (30, 130′) or longitudinal grooves (130) are arranged.

10. The attachment according to claim 1, wherein
the male part (10, 10′, 10″, 50, 50′, 110′) has a head part (13, 53) and wherein
the cross sectional area, which has the approximal part (11, 11′, 11″, 51, 51′, 111, 111′) sectioned in a plane of section (A-A), which is spanned by the directions, in which the longitudinal grooves (20, 120′) or longitudinal ribs (120) of the male part run, is greater than that cross sectional area, which has the head part sectioned in a plane parallel to the plane of section.

11. The attachment according to claim 1, wherein the male part (10, 10′, 10″, 50, 50′, 110, 110′) and/or the housing have bevelled surfaces (56, 69) on the basal side.

12. The attachment according to claim 1, wherein the longitudinal grooves (20, 120′, 130) of the male part (10, 10′, 10″, 50, 50′, 110′) or the female part (125) have a round cross section.

13. A method for the production of an attachment according to claim 1, wherein the male part (10, 10′, 10″, 50, 50′, 110, 110′) is produced by means of a dental CAD/CAM-System.

14. The method according to claim 13, wherein the CAD/CAM-System is used to produce the male part (10, 10′, 10″, 50, 50′, 110, 110′) integrally with a crown, a crown cap (95), a bridge or a bridge structure.

15. The attachment according to claim 2 wherein the two longitudinal grooves or longitudinal ribs of the female part (25, 65) forms a stabilising rib (30) or stabilising groove, which extends from the one longitudinal side (31a) of the female part via the occlusal side (31b) of the female part to the other longitudinal side (31c) of the female part.

16. The attachment according to claim 3 wherein the round cross section is substantially constant along the stability groove (20) or stabilising rib (30).

17. The attachment according to claim 5 wherein the friction part or the occlusal side comprises a seating surface (76) which rests on the male part (50, 50′).

18. The attachment according to claim 12 wherein the round cross section has substantially circular segmental shape.
